(19) United States
(12) Patent Application Publication
(10) Pub. No.: US 2006/0066393 A1
(43) Pub. Date: Mar. 30, 2006

(54) High-speed, low-power, low-skew, low-voltage differential receiver

(76) Inventors: Bradley Kendall Davis, Fort Collins, CO (US); Francis Creed, Westford, MA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/957,149

(22) Filed: Sep. 30, 2004

(51) Int. Cl. G06G 7/12

(52) U.S. Cl. 327/563

(57) ABSTRACT

A differential receiver uses an operational trans-conductance amplifier (OTA) to bias the common mode output voltage of the input stage to an inverter threshold voltage, Vth. Large-gate N-MOS transistors are used to provide the bias, and thin-gate NMOS transistors are used as the input switching transistors. A double cross-coupled latch creates a high-gain configuration for small differential signals and limits the gain and swing non-linearly for large signals, without imposing a large transition delay. Matched resistors between the outputs of the double cross-coupled latch provides a measure of the common-mode output voltage of the input stage, and an inverter with input shorted to output provides a measure of an inverter threshold voltage Vth. The OTA compares the measure of the common-mode output voltage and measure of the inverter threshold voltage, and provides a control current to the large-gate NMOS transistors to maintain the mid-point of the common-mode output voltage at a constant voltage.

### FIELD OF THE INVENTION

This invention relates to the field of electronic circuits, and in particular to a low-voltage differential signal (LVDS) receiver with low skew and low power consumption, that is suitable for operation across a frequency range from DC through multiple GigaHertz.

### BACKGROUND ART

Differential signals are commonly used in electronic circuits and systems. The use of differential signals provides the opportunity to apply noise-canceling techniques. When the difference between two signals is used to determine the logic value associated with the information being communicated by the two signals, any noise that is common to both signals is cancelled/eliminated. The use of differential signaling typically requires complementary symmetry between the pair of differential signals, including coincident switching, so that the difference signal traverses between logic levels quickly, minimizing the time that the difference signal is in an ambiguous and/or potentially erroneous state. An offset of switching time between the pair of differential signals is termed “skew”, and the time required for each signal in the pair to change state is termed “transition time”. Low-skew and low-transition-time circuits are preferred for optimal differential signal processing, particularly at high speeds.

Differential signaling is particularly effective for transmitting signals between remote transmitters and receivers. In such an application, the differential receiver is designed to receive a potentially noisy and attenuated signal and to provide a substantially noise-free signal that is suitable for driving subsequent logic gates. The differential receiver should accept a wide amplitude range of the received signal, in terms of both the average voltage level of the differential signal pair (common mode input voltage) and the difference voltage between the pair (differential voltage). For maximum utility, the differential receiver should operate across a wide frequency range, including DC (static) operation, and should consume minimal power. At very high frequencies, such as Gigahertz-range signals, differential skew and asymmetry increases the likelihood that the value of the received signal will be miss-read, particularly in a noisy environment.

U.S. Pat. No. 6,275,073, “DIFFERENTIAL INPUT CIRCUIT, issued 14 Aug. 2001 to Tokuhiro, teaches a differential receiver as illustrated in FIG. 1, and is incorporated by reference herein. The circuit uses both NMOS and PMOS input transistor to allow for a large common mode input voltage range. However, the input transistor pair pia, pib is operated with a different drain-source voltage than the input transistor pair nia, nib. This input offset is further exasperated if short channel lengths and large W/L ratios are employed to maximize bandwidth. A P-channel/N-channel input offset affects the symmetry of the processed received signal, because the switching points of the P-channel and N-channel devices will differ.

FIG. 2 illustrates a differential receiver that is designed to use the same transistor pair (nia-pia, nib-pib) to generate both inverting (drain) and non-inverting (source) outputs, thereby providing a symmetric output. When the voltage supply Vdd is in the range of 1.8 v, thin-film transistors can be used to accommodate rail-to-rail common mode input voltages. If higher common-mode input voltages must be accommodated, thick-gate transistors may be used with a corresponding higher supply voltage. However, thick-gate transistors, and particularly thick-gate PMOS transistors are substantially slower. Additionally, because resistors R1a, R1b, R1c, R1d have the same value, the gain of the input stage is less than one, and thus the common-mode-rejection-ratio (CMRR) is low. CMRR is a measure of the effectiveness of the stage to cancel noise that is present on both differential input signals, and a high CMRR is particularly important for reliably receiving low-level signals. In addition to a relatively low CMRR, the circuit of FIG. 2 preferable includes low-valued resistors R1a, R1b, R1c, and R1d, to maximize bandwidth and pulse-transition time, and thus consumes substantial current/power.

In each of the above example circuits, both PMOS and NMOS transistors are used to provide for a wide range of input voltages. Because the characteristics of P-channel devices differ from the characteristics of N-channel devices, symmetric performance is typically obtained by appropriately sizing the transistors to provide similar characteristics. However, providing such characteristic-matching techniques across a range of process, voltage, and temperature (PVT) conditions is difficult, if not impossible, particularly when symmetric performance is required at very high frequencies.

FIG. 3 illustrates a common technique for providing consistent performance over a range of PVT conditions, via the use of a single channel-type. The common-mode (CM) feedback loop is configured to bias the common-mode output of the input stage at an inverter threshold, Vth.

Large input signals can overload a conventional input stage, causing the input to be improperly biased, which leads to an increase in the likelihood of miss-reads of the input signal. By biasing the output of the input stage at a constant voltage via the CM Feedback loop of FIG. 3, the potential improper biasing of the input stage caused by large input signals can be avoided, provided that the speed of the feedback loop is sufficient to quickly correct the bias. To provide high gain, high valued resistors R1, R2 are preferably used, but large resistors have an adverse affect on achievable bandwidth, transition speed, and loop speed. Diode-connected transistors may replace the resistors R1, R2, but the gate-source capacitance of such devices may adversely affect the frequency response characteristics of the input stage.

### SUMMARY OF THE INVENTION

It is an object of this invention to provide a low-power low-skew differential receiver. It is a further object of this invention to provide a differential receiver that accommodates a wide range of input voltage. It is a further object of this invention to provide a differential receiver that operates across a wide range of frequencies. It is a further object of this invention to provide a differential receiver that operates consistently over a wide range of PVT parameters.

These objects, and others, are achieved by providing a differential receiver that uses an operational trans-conductance amplifier (OTA) to bias the common mode output voltage of the input stage to an inverter threshold voltage, Vth. Large-gate N-MOS transistors are used to provide the bias, and thin-gate NMOS transistors are used as the input switching transistors. A double cross-coupled latch creates a high-gain configuration for small differential signals and limits the gain and swing non-linearly for large signals, without imposing a large transition delay. Matched resistors between the outputs of the double cross-coupled latch provides a measure of the common-mode output voltage of the input stage, and an inverter with input shorted to output provides a measure of an inverter threshold voltage Vth. The OTA compares the measure of the common-mode output voltage and measure of the inverter threshold voltage, and provides a control current to the large-gate NMOS transistors to maintain the mid-point of the common-mode output voltage at a constant voltage.

### BRIEF DESCRIPTION OF THE DRAWING

FIG. 1 illustrates an example prior art differential receiver.

FIG. 2 illustrates another example prior art differential receiver.

FIG. 3 illustrates a prior art differential receiver with a common-mode feedback loop.

FIG. 4 illustrates an example embodiment of a differential receiver in accordance with this invention.

FIG. 5 illustrates an example embodiment of a differential receiver in accordance with this invention with improved input and output characteristics.

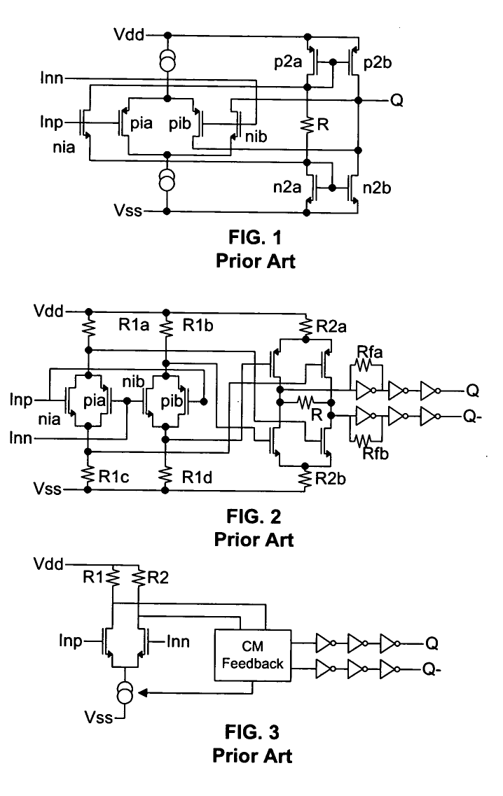

Throughout the drawings, the same reference numeral refers to the same element, or an element that performs substantially the same function.

### BEST MODE FOR CARRYING OUT THE INVENTION

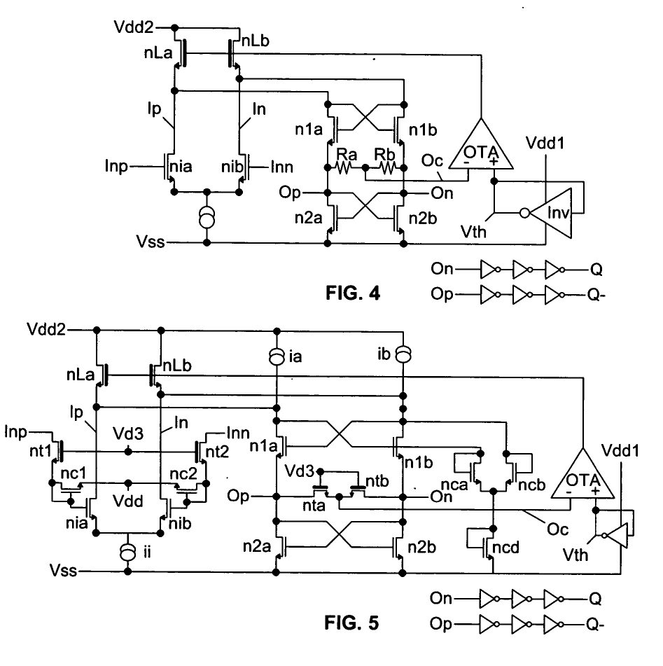

FIG. 4 illustrates an example embodiment of a differential receiver in accordance with this invention. The input stage comprises transistors nia, nib. These transistors nia, nib are preferably thin-gate transistors with minimum channel-length and a large width/length (W/L) ratio, to provide low input offset and noise while maximizing bandwidth and transconductance.

In accordance with one aspect of this invention, bias current for the input stage is provided by thick-gate transistors nLa and nLb, and this bias current is controlled by an operational transconductance amplifier OTA that is configured to maintain the common-mode output voltage at a constant voltage, Vth. This constant voltage Vth is provided by an inverter INV having its input coupled to its output. Preferably, the OTA is a single stage operational amplifier, so that the delay around this common-mode feedback loop is small, thereby assuring stability and quick response to reject power supply variations.

In accordance with another aspect of this invention, the output stage comprises double cross-coupled latches n1a, n1b, and n2a, n2b, preferably minimum length thin-gate NMOS devices. Matched resistors Ra, Rb form the output load, and the common-mode output voltage, (Op+On)/2, is obtained from the midpoint of this load. As noted above, this common-mode output voltage is compared to the inverter threshold voltage Vth at the OTA, and the bias of the input stage is controlled to assure that the common-mode output voltage is held equal to this threshold voltage.

The double cross-coupled latches, comprising transistors n1a, n1b, n2a, n2b, provides low common-mode impedance and high differential gain, which is particularly advantageous for receivers that accommodate a wide range of differential signals. For small differential signals, the cross-coupled latches provide high gain, thereby providing a high common-mode rejection ratio, and decreased input-related offset and noise contributions after the input stage. For large signals, the cross-coupled latches limit the gain and swing non-linearity without the presence of a large time constant. The low differential input impedance provides low delay-time and transition-time constants, as well as a clamping function by limiting the differential output voltage Op-On from growing too large. By limiting the differential output voltage, the cross-coupled latches provide for fast recovery and symmetric performance.

Using the double cross-coupled latches as illustrated, the output voltages Op and On are approximately two thin-gate gate-source voltages Vgs above Vss, thereby limiting the drain-source voltage of the input transistors nia, nib to about 2*Vgs. This enables the aforementioned preferable use of thin-gate transistors in the input stage. Because threshold voltage mismatch is proportional to the thickness of the gate, the use of thin-gate transistors decreases the overall offset. Also, because the transition frequency is inversely proportional to the square of the length of the transistor gate, minimum-gate-length NMOS devices maximize speed.

As in conventional circuits, the outputs Op, On are provided to a string of inverters to provide output signals Q and Q- that are suitable for driving other devices without loading the outputs Op, On. Typically, the first inverter stage is configured to present minimal load to the outputs Op, On, and may include a feedback path to enhance transition performance. Subsequent inverters in the stage are sized progressively larger until the desired drive characteristics are achieved.

Note that the signal path of the circuit of FIG. 4 uses only NMOS devices, and therefore consistency of performance can be maintained across a wide range of process, voltage, and temperature variations.

FIG. 5 illustrates an example embodiment of a differential receiver in accordance with this invention with improved input and output characteristics, compared to the example circuit of FIG. 4.

Current sources ia and ib reduce the load on the bias transistors nLa, nLb by providing current to the cross-coupled latches. The gate-source capacitance of nLa and nLb can be substantial and can thereby limit speed. By decreasing the amount of current required from nLa and nLb, this capacitance is reduced. Preferably, ia and ib have a large gate-source voltage, to reduce their contribution to noise and offset, and may include, for example, thick-film PMOS transistors. The use of current sources ia and ib increases the effective load resistance of transistors nLa, nLb, thereby reducing the amount of differential input current that is shunted away from the output stage. Additionally, because the capacitance of current sources ia, ib is low, the overall capacitance at Op and On is reduced. The configuration of the output stage prevents the current sources ia and ib from leaving saturation, thereby avoiding the accumulation of charge at the current sources, which would slow overdrive recovery.

Clamping transistors nca, ncb, ncd are added to facilitate an increase in gain in the output stage. Gain is increased by reducing the sizes of n1a and n1b. This increase in gain, however, increases the risk of exceeding the maximum allowed drain-source voltages of n1a, n1b; additionally, if the output differential Op-On becomes too large, poor recovery will introduce skew. The clamping transistors nca, ncb, ncd are configured to limit the output differential to the minimum required to reliably drive the inverter chain at the required data rate; in this example, to two diode threshold voltages. The diode-configured transistors nca, ncb, ncd shunt large signal swings, while having little or no effect on small signal swings. The use of this configuration of clamping transistors also facilitates the aforementioned limiting of the maximum drain-source voltages across the input transistors nia, nib to allow the use of thin-gate devices in the input stage.

Thick-gate triode-configured NMOS devices nta, ntb replace the load resistors Ra, Rb of FIG. 4, to further reduce power consumption. Preferably, the devices nta, ntb each comprise a string of devices, to improve the linearity of the sensed common-mode output voltage, and thereby minimize variations in the controlled common-mode voltage.

A common-mode input clamp comprising nt1, nc1 and nt2, nc2 protects the current source ii from high common mode input levels.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

What is claimed is:

1. A receiver that is configured to receive a pair of differential input signals and to provide therefrom a pair of differential output signals, comprising:
an input stage that includes:
an input circuit that is configured to receive the input signals and provides a pair of differential intermediate signals, and
a bias circuit that is configured to provide a controlled bias current to the input circuit; and
an output stage that includes:
an output circuit is configured to receive the intermediate signals and to provide therefrom the output signals, and a common-mode output signal, and
a comparator, operably coupled to the output circuit and the bias circuit, that is configured to compare the common-mode output signal to a referenced voltage and to provide therefrom a control signal to the bias circuit to effect control of the controlled bias current;
wherein
the input circuit includes a pair of input transistors that are configured to receive the input signals
the bias circuit includes a pair of bias transistors,
each of the bias transistors being in series with a corresponding input transistor of the pair of input transistors, and
each gate of the bias transistors being configured to receive the control signal from the comparator.

2. The receiver of claim 1, wherein
the output circuit includes
a pair of cross coupled latches that are configure in series between the intermediate signal and a supply voltage, the output signals being provided between the pair of cross coupled latches.

3. The receiver of claim 1, wherein
the common-mode output signal corresponds substantially to an average of the output signals.

4. The receiver of claim 1, wherein
the output stage further includes
a clamping circuit, operably coupled to the output circuit, that is configured to limit the output signals.

5. The receiver of claim 1, wherein
the input transistors are each thin-gate transistors, and
the bias transistors are each thick-gate transistors.

6. The receiver of claim 1, wherein
the input circuit further includes
a pair of diode-configured transistors that are connected in series between the input signals and the input transistors.

7. The receiver of claim 6, wherein
the input circuit further includes
a pair of triode-configured transistors that are connected in series between the input signals and the diode-configured transistors.

8. The receiver of claim 1, wherein
the input circuit further includes
a pair of triode-configured transistors that are connected in series between the input signals and the input transistors.

9. The receiver of claim 1, wherein
the reference voltage is provided by an inverter with coupled input and output.

10. The receiver of claim 1, wherein
the comparator includes an operational transconductance amplifier.

11. The receiver of claim 1, further including:
a string of triode-configured transistors operably coupled between the output signals, wherein
the common-mode output voltage is sensed at a midpoint of the string.

12. A receiver that is configured to receive a pair of differential input signals and to provide therefrom a pair of differential output signals, comprising:
an input stage that includes
an input circuit that is configured to receive the input signals and provides a pair of differential intermediate signals; and
an output stage that includes
an output circuit is configured to receive the intermediate signals and to provide therefrom the output signals;
wherein
the output circuit includes
a pair of cross coupled latches that are configure in series between the intermediate signal and a supply voltage, the output signals being provided between the pair of cross coupled latches.

13. The receiver of claim 12, wherein
the output stage further includes
a clamping circuit, operably coupled to the output circuit, that is configured to limit the output signals.

14. The receiver of claim 12, wherein
transistors of at least one of the pair of cross-coupled latches are each thin-gate transistors.

15. The receiver of claim 12, further including
a pair of current sources that are configured to provide current to the cross coupled latches.

16. The receiver of claim 12, wherein
the pair of cross-coupled latches are configured to limit a maximum voltage at the input stage, thereby allowing use of thin-gate transistors in the input stage for signal propagation.
